(19) United States
(12) Patent Application Publication
(10) Pub. No.: US 2006/0108079 A1
(43) Pub. Date: May 25, 2006

(54) Multi-fold panel assemblies

(76) Inventors: David Frank Burggraaf, Auckland (NZ); Ashley Clive Jones, Auckland (NZ)

Correspondence Address: JACOBSON HOLMAN PLLC, 400 SEVENTH STREET N.W., SUITE 600, WASHINGTON, DC, 20004, US

(21) Appl. No.: 10/523,998

(22) PCT Filed: Aug. 13, 2003
(86) PCT No.: PCT/NZ03/00179

§ 371 Date: Oct. 27, 2005

(30) Foreign Application Priority Data
Aug. 14, 2002 (NZ) 520792
May 15, 2003 (NZ) 52553

(51) Int. Cl. E05D 15/26

(52) U.S. Cl. 160/206

(57) ABSTRACT

A closure assembly (40) of an opening in a building including at least two mutually pivoted panels (41, 42, 43) mounted with the mutual pivot axis (44) at least substantially vertical. The panels are movable between a closed condition whereby the at least two panels at least substantially in mutual alignment provide at least a partial closure of the opening in or substantially parallel to the plane of the opening, and an opened condition whereby the at least two panels, mutually disaligned by having pivoted mutually towards each other, are substantially clear of the plane of the opening. A proximate panel (41) is pivoted by a vertical pivot axis substantially in the plane of the opening at adjacent a vertical periphery of the opening (45). The distal region of distal panel (42) is supported by at least one supporting runner. The supporting runner is guided by a support track (51) which is skewed with respect to the plane of the opening and has the affect of spacing the supporting runner out of the plane of the opening at the vertical periphery.

### FIELD OF THE INVENTION

The present invention relates to multi-fold window and/or door assemblies.

In particular, the present invention is directed to a multi-fold arrangement adapted to lend itself to a more expansive opening configuration compared to alternative arrangements.

### BACKGROUND OF THE INVENTION

Typical bifold assemblies as disclosed in our New Zealand Patent Specification No. 336696, are capable of being folded or opened to the edge of the window or door opening. In such instances the folded windows or door panels create an obstruction of sorts, be it visual or otherwise. Such prior art arrangements do not allow the entire wall opening to be fully utilised as they are constrained by hinges built into tracking arrangements. It would be an advantage for multi-fold panel assemblies to have the prospect of clearing the opening of the panels when in the opened condition. Our New Zealand Patent Specification No. 505958 sought to achieve this outcome by releasing the distal pivot axis from the tracks or track in the plane of the opening. The procedure of our New Zealand Patent Specification No. 505958 is effective for the purpose but does require sturdy mounts as, in the open folded condition against the building structure away from the opening, loadings of the panel pairs is carried through the sole remaining pivot axis.

### BRIEF DESCRIPTION OF THE INVENTION

It is an object of the present invention to more fully exploit the space provided for by a wall opening for which a multifold window and/or door assembly is intended.

The present invention is therefore directed to an arrangement, for at least a bifold panel (glazed or otherwise) structure, and whether for door or window purposes or a hybrid of both, whether top or bottom mounted (supported), which alone or in conjunction with a mirrored arrangement can provide an alternative to existing multifold panel systems. As used therein and herein the term “plane of the opening” preferably includes a straight plane but may include a curved or other shaped opening and consequently the “plane of the opening” should be interpreted as including any form of opening capable of being tracked substantially to the shape of the opening.

Where reference herein is made to the “mutual disalignment” of panels it is meant a positioning of the panels in a non co-planar condition. Such mutual disalignment is preferably in the form of a concertina like condition where the at least two panels are in a substantially overlying position.

The present invention is directed to assemblies, methods and procedures that are capable of achieving a similar outcome as that of our New Zealand patent specification no. 505958 as far as allowing the panels to be cleared from the opening of the structure when open or to at least provide the public with a useful choice.

In one aspect the present invention consists in a closure assembly of an opening of or in a building or like structure, said closure assembly including at least two mutually pivoted panels (glazed or otherwise) mounted with the mutual pivot axis at least substantially vertical and so as to be movable between:

(i) a closed condition whereby said at least two panels at least substantially in mutual alignment provide at least a partial closure of said opening in or substantially parallel to the plane of the opening, and

(ii) an opened condition whereby said at least two panels, mutually disaligned by having pivoted mutually towards each other, are substantially clear of the plane of the opening and where one of each, or all of at least two panels, lie at an acute angle or parallel with respect to the plane of the opening,

wherein one of said panels (the “proximate panel”) is pivoted by an at least substantially vertical pivot axis substantially in the plane of the opening at and/or adjacent a vertical periphery of said opening (“the proximal periphery”),

and wherein the distal region of the other panel (the “distal panel”) is supported by at least one supporting runner,

wherein the supporting runner running on a support track which, at least in part is skewed, angled or angling, cranked or curved (hereafter “skewed”) with respect to the plane of said opening, has the affect of spacing the supporting runner out of the plane of said opening at/or adjacent said proximal periphery.

Preferably the proximate panel is pivoted by a substantially vertical pivot axis fixed relative to said opening.

Preferably said proximate panel is pivoted by a substantially vertical pivot axis horizontally movable relative to and within the plane of the opening.

Preferably said supporting runner includes a wheeled bogie engaged with the support track.

Preferably said support runner includes a vertical axis pivot to allow said wheeled bogie to pivot relative to said distal panel about a vertical axis.

Preferably said vertical axis of said pivot of said wheeled bogie is located at the mid thickness of said distal panel.

Preferably the support track is substantially rectilinear in form and is at an acute angle with respect to the plane of the opening.

Preferably the support track is at least in part rectilinear in form and said part is at an acute angle with respect to the plane of the opening.

Preferably the support track is rectilinear in form and parallel with the plane of the opening (preferably in the plane of the opening) save for that part thereof immediately proximal to the proximal periphery, where said track is angled to the plane of said opening to step the supporting runner out of the plane of the opening.

Preferably the support track is curved.

Preferably the distal region of the distal panel is supported by one supporting runner affixed at either the top or bottom (the “vertical supported location”) of the distal panel.

Preferably the other of said top or bottom to said vertical supported location is associated with a guiding runner tracked by a guiding track in the plane or parallel to the plane of the opening, such guiding runner nevertheless allowing by means of an extensile association of the guiding runner with the distal panel, movement for the distal panel in following the support track defined locus allowing the distal region of the distal panel to move as guided and pivoted with respect to the opening by the supporting runner guided by the support track.

Preferably the other of said top or bottom to said vertical supported location is associated with a guiding runner tracked by a guiding track in the plane or parallel to the plane of the opening, such guiding runner including an extensile arm pivotally attached to the distal panel, said extensile arm allowing the following of the support track defined locus required to allow the distal region of the distal panel to move as constrained by said support track.

Preferably the guiding runner includes an articulation means extending in a pivotal manner between the distal panel (at or towards the distal region) said articulation means being further pivotally associated with said guiding track via a runner bogie located with and guided by the guiding track, thereby providing said extensile association.

Preferably said articulation means is a rigid arm.

Preferably said rigid arm extends perpendicular to said plane of said opening when said panels are in said open condition.

Preferably the support runner is provided at the top of the distal panel.

Preferably the guide runner is located at the bottom of the distal panel.

Preferably the guide runner is provided at the top of the distal panel and the supporting runner is located at the bottom of the distal panel.

Preferably the distal region of the distal panel is supported by a top and bottom located supporting runner, each supporting runner running in a respective said support track, disposed at the top and bottom of the opening.

Preferably the proximal panel is pivoted by a fixed vertical pivot axis at the proximal periphery.

Preferably said panels in an open position, lie substantially parallel to the plane of the opening.

Preferably the closure assembly is fully framed.

Preferably the perimeter of said closure assembly is defined by a frame structure of a size commensurate to being received in said opening of or in said building or like structure.

Preferably the perimeter of said closure assembly is defined by a frame structure of a size commensurate to being received in said opening of or in said building or like structure said frame including a top frame extrusion, and a bottom frame extrusion parallel to said top frame extrusion and to extend horizontally in use, and two side frame extrusions affixed to and extending between said top and bottom frame extrusion and parallel to each other and to in use extend vertically.

Preferably said frame is at least in part an assembly of extruded forms.

Preferably said supporting runner is a top runner affixed to a top or upper part of said distal panel, and wherein said opening of or in said building includes head framing, said support track is incorporated in a head assembly, said head assembly including

a) a longitudinally extending foundation member to be fastened to the head framing of said opening with its longitudinal direction parallel to the plane of said opening,

b) a subassembly carrying the support track, fastened to said foundation member yet in a manner to allow the displacement of the said support track in a manner selected from one or more of
(i) a linear manner to and from the bottom of said opening, and
(ii) a manner to allow the tilt of said track about a horizontal axis parallel to the plane of said opening.

Preferably said supporting runner is a top runner affixed to a top or upper part of said distal panel, wherein said top frame member is a head assembly, said head assembly including

a) a longitudinally extending foundation member to be fastened to the building and in a manner with its longitudinal direction parallel to the plane of said opening,

b) a subassembly carrying the support track, fastened to said foundation member yet in a manner to allow the displacement of the said support track in a manner selected from one or more of
(i) a linear manner to and from the foundation member, and
(ii) a manner to allow the tilt of said track about a horizontal axis parallel to the plane of said opening.

Preferably said foundation member is fixed to said side frame members.

Preferably said subassembly is engaged to said foundation member by two arrays of vertically extending adjustment screws, a first array and a second array parallel to each other and to the plane of the opening, wherein the differential adjustment of the screws in one array to the other array inducing said tilt and wherein corresponding adjustment of the screws in the first array and the second array inducing the linear displacement.

Preferably said subassembly includes a pelmet with which said track is fastened and disposed therefrom in a manner to be exposed for engagement with the supporting runner.

Preferably said pelmet extends outwardly from the plane of the opening sufficient to present from below thereof said support track and to allow the spacing of the supporting runner to assume the opened condition.

Preferably said pelmet is an elongate substantially constant cross section extruded member.

Preferably said pelmet includes trimming panels on each side of said support track spanning the gap between said support track and the longitudinal edges of said pelmet.

Preferably said first array of fastening screws is provided parallel to and on a first side of said plane of said opening and the second array is provided parallel to and on the other side of said plane of said opening.

Preferably said screws of each array are equispaced.

Preferably a locking pin is provided fixed to said structure, said locking pin positioned to engage at distal region of said distal panel against an outwardly facing surface of said distal panel when said panels are at and proximate to its closed condition to capture from moving outwardly.

Preferably a locking pin is provided fixed to said frame, said locking pin positioned to engage at distal region of said distal panel against an outwardly facing surface of said distal panel when said panels are at and proximate to its closed condition to capture said distal region against a jam portion of said frame to thereby prevent said distal region from moving outwardly.

Preferably said distal panel is supported at a top or bottom thereof by a said support runner and wherein at the other of said top or bottom the distal region of said distal panel includes an outwardly facing surface and wherein a locking pin is provided fixed to said frame structure, said locking pin positioned to engage the outwardly facing surface of said distal panel when said panels are at and proximate to its closed condition to capture said distal region against a jam portion of said frame to thereby prevent said distal region from moving outwardly.

Preferably said outwardly facing surface is a concealed to the outside surface of said distal panel.

Preferably provided to the proximal periphery disposed region of said proximal panel on the to be distal panel facing side thereof when in the opened condition, is a first mutually attractive means, the distal panel being provided at a corresponding location to the location of said first mutually attractive means on a proximal panel facing side thereof when in the opened condition, with a second mutually attractive means to thereby allow the interaction of said mutually attractive means when said panels are in the opened condition to encourage said distal region of said distal panel to remain engaged to the proximal periphery disposed region of said proximal panel.

Preferably said first and second mutually attractive means are magnetically-attractive means.

Preferably said first and second mutually attractive means are both magnets.

Preferably said first and second mutually attractive means are positioned towards the bottom of said panels.

In a second aspect the present invention consists in a bifold door and/or window structure

at least a proximal panel and a distal panel

wherein

(a) the distal panel is provided at/or adjacent a lower distal region with a pivot on an extension of or from a lower track runner tracked in the plane of the opening to be closed by the door and/or window panels and,

(b) the distal panel is provided at or adjacent an upper distal region with a means to provide pivot tracking from a support track of the structure, said support track being skewed at least in part (whether straight, curved, kinked or otherwise)

and wherein together (a) and (b) have the affect of moving a thus defined common distal pivot axis of the distal panel out of the plane of the opening as the panels are opening thereby to allow the bifold door or window structure concertina back away from the opening with the proximal panel adjacent the building structure and the distal panel adjacent the proximal panel.

In a further aspect the present invention consists in a guiding runner for supporting a lower distal region of distal panel of a bifold or multi-fold door and/or panel structure from a track, said guiding runner having an arrangement adapted to pivotally attach to said distal region of said distal panel,

a runner adapted to track said track, and

a link between the pivotal attachment and the runner, said link including two substantially parallel pivot axes whereby the link can range in its disposition from being aligned or substantially aligned in the plane of the tracking locus or extend outwardly therefrom to effectively space the pivot most proximal to the door and/or window panel from such plane of the tracking locus.

Preferably such a guiding runner is substantially as hereinafter described with reference to any one or more of FIGS. 1B, 2, 3, 5, 6A-C, 11, 12.

Preferably extrusions for framing an opening in a structure and for providing tracks for such a structure, wherein in subassembly or assembly they are adapted to form part of an assembly or structure of the closure assembly as hereinbefore described.

In a further aspect the present invention consists in, in a building structure, a pair of tracks at an opening for a bifold or the like panel assembly, the lower track being in the plane of the opening and the upper track being skewed outwardly of the plane of the opening.

In a further aspect the present invention consists in a bifold door and/or window structure comprising

at least a proximal panel and a distal panel

wherein

(a) the distal panel is provided at/or adjacent a lower or upper distal region with a pivot on an extension of or from a guiding track runner tracked in the plane of the opening to be closed by the door and/or window panels and,

(b) the distal panel is provided at or adjacent the other of said upper or lower distal region with a means to provide a pivot tracking from a support track of the door or window structure, said support track being skewed at least in part (whether straight, curved, kinked or otherwise)

and wherein together (a) and (b) have the affect of moving a thus defined common distal pivot axis of the distal panel out of the plane of the opening as the panels are opening thereby to allow the bifold door or window structure concertina back away from the opening with the proximal panel adjacent the building structure and the distal panel adjacent the proximal panel.

In a further aspect the present invention consists in a guiding runner for supporting a lower or upper distal region of distal panel of a bifold or multi-fold door and/or panel structure from a track, said guiding runner having an arrangement adapted to pivotally attach to said distal region of said distal panel,

a runner adapted to track said track, and

a link between the pivotal attachment and the runner, said link including at least two substantially parallel pivot axes whereby the link can range in its disposition from being aligned or substantially aligned in or acute to the plane of the tracking locus when said bifold door is closed or extend outwardly therefrom to effectively space the pivot most proximal to the door and/or window panel from such plane of the tracking locus.

Preferably such a guiding runner is substantially as hereinafter described with reference to any one or more of FIGS. 1B, 2, 3, 5, 6A-C, 11, 12.

Preferably extrusions for framing an opening in a structure and for providing tracks for such a structure, wherein in subassembly or assembly they are adapted to form part of a closure assembly as hereinbefore described.

In a further aspect the present invention consists in, in a building structure, a pair of tracks at an opening for a bifold or the like panel assembly, a first of said tracks positioned either as a lower or upper track and being in the plane of the opening and the second of said tracks being opposite to the first of said tracks being skewed outwardly of the plane of the opening.

In a further aspect the present invention consists in, in a building structure, a pair of tracks at an opening or a bifold or the like panel assembly, the upper track being in the plane of the opening and the lower track being skewed outwardly of the plane of the opening.

Preferably said such track is of a kind capable of being used in a closure assembly as hereinbefore described.

In a further aspect the present invention consists in a building including a closure assembly to an opening of said building, said closure assembly including at least two mutually pivoted panels (glazed or otherwise) mounted with the mutual pivot axis at least substantially vertical and so as to be movable between:

(i) a closed condition whereby said at least two panels at least substantially in mutual alignment provide at least a partial closure of said opening in or substantially parallel to the plane of the opening, and

(ii) an opened condition whereby said at least two panels, mutually disaligned by having pivoted mutually towards each other, are substantially clear of the plane of the opening and where one of each, or all of at least two panels, lie at an acute angle or parallel with respect to the plane of the opening,

wherein one of said panels (the “proximate panel”) is pivoted by an at least substantially vertical pivot axis substantially in the plane of the opening at and/or adjacent a vertical periphery of said opening (“the proximal periphery”),

and wherein the distal region of the other panel (the “distal panel”) is supported by at least one supporting runner,

wherein the supporting runner running on a support track which, at least in part is skewed, angled or angling, cranked or curved (hereafter “skewed”) with respect to the plane of said opening, has the affect of spacing the supporting runner out of the plane of said opening at/or adjacent said proximal periphery.

In still a further aspect the present invention consists in extrusions for framing an opening in a structure and for providing tracks for such a structure, wherein in subassembly or assembly they are adapted to form part of an assembly or structure of the present invention.

In still a further aspect the present invention consists in, in a building structure, a pair of tracks at an opening for a bifold or the like panel assembly, a first of said tracks positioned either as a lower or upper track and being in the plane of the opening and the second of said tracks being opposite to the first of said tracks being skewed outwardly of the plane of the opening.

In still a further aspect the present invention consists in a building structure, a pair of tracks at an opening or a bifold or the like panel assembly, the upper track being in the plane of the opening and the lower track being skewed outwardly of the plane of the opening.

Preferably said such track is of a kind capable of being used in an assembly of any of the kinds herein defined or described.

To those skilled in the art to which the invention relates, many changes in construction and widely differing embodiments and applications of the invention will suggest themselves without departing from the scope of the invention as defined in the appended claims. The disclosures and the descriptions herein are purely illustrative and are not intended to be in any sense limiting.

### BRIEF DESCRIPTION OF THE DRAWINGS

Preferred forms of the present invention will now be described with reference to the accompanying drawings in which;

FIG. 1A illustrates an exterior view of a multi-fold panel assembly of the present invention in a simplified form,

FIG. 1B is a plan sectional elevation of a multi-fold door consisting of two panels together with a third panel hinged there of, in both the open and closed condition guided there between by utilising the skewed track of the present invention,

FIG. 2 is a vertical cross-section elevation looking along line II of FIG. 1, showing the multi-fold panel in a closed position showing the detail of the top assembly and track therein and the bottom assembly with the bottom bogie in its track,

FIG. 3 is a similar view to FIG. 2 taken looking along lines III of FIG. 1 when the multi fold door is in the open condition,

FIG. 4 is a detailed view of the top extrusions with its skewed track shown in FIG. 2,

FIG. 5 is a close up view of the bottom assembly and bogie as shown in FIG. 2,

FIG. 6A shows a side elevation of the bogie configured in this instance for a bottom track,

FIG. 6B shows a top elevation of the same bogie in its fully extended form, a position it would assume in FIG. 1 when the multi-fold panel is fully open,

FIG. 6C shows the same bogie as of 6B but as it would lie in the fully closed position as shown in FIG. 1 when the door is closed,

FIG. 7A illustrates a panel catcher and mounting nut shown in side elevation,

FIG. 7B is a top elevation of 7A,

FIG. 8 is a vertical sectional view looking along a multi fold panel assembly analogues to FIG. 1 in region III of FIG. 1 but showing a magnetic or mutually attractive means used as an alternative for the bogie shown in FIG. 6,

FIG. 9 is a horizontal elevation of a rub strip shown in location in FIG. 5,

FIG. 10 depicts the multi-fold panel assembly in a similar view to that of FIG. 1 within the addition of the top track and also the change in orientation of the bottom following assembly, but with a different configuration of lower follower bogie assembly,

FIG. 11 shows a plan view close up of the closed door and they orientation of the bottom runner and also the orientation of the top runner and its orientation in the skewed top runner,

FIG. 12 shows a view similar to that of FIG. 11 however the second panel 42 is in its last movement before closing and the bump strip 102 can be seen protecting the mohair seal 101 which partially protrudes past the horizontal surface of the bump strip, and the approximate location of the retention pin 103 can also be seen,

FIGS. 13-16 show plan views of various configurations of panels, and

FIG. 17 shows a plan view of an alternative top rail form.

### DETAILED DESCRIPTION OF THE INVENTION

When using a door consisting of multiple panels to close or partially close a door way consideration needs to be given to the not in consequential weight of such assemblies. The panels comprising the door are often glazed and thus in conjunction with the panel frame can weigh a significant amount. This weight poses more problems as the door is folded out of cover of the opening. Support of one or more of the panels by suspending from above or supporting from below can alleviate this problem. Such support can also guide the door in its opening and closing. However to make the most of the space available the door needs also to fold flat and to present minimal protrusion from the building, also preferably parallel with the building envelope, when opened.

The present invention utilises a modified guide track for example at the top (or at the bottom) of the door frame, and extensile member linked bottom (or top) tracked guide can allow the door to be sufficiently supported and guided as well as folding clear out of the way of the opening.

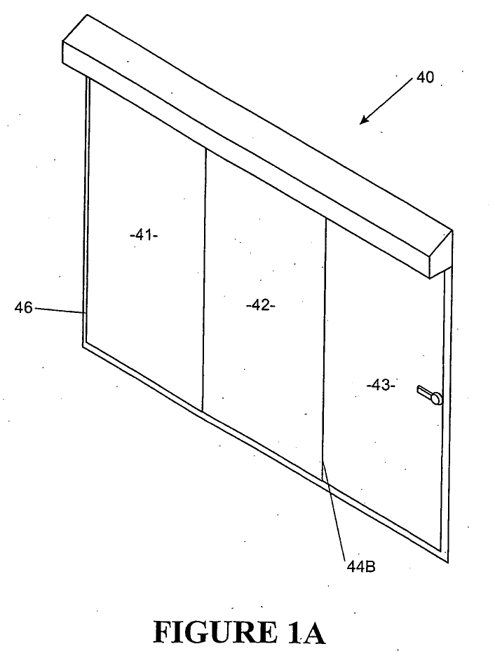

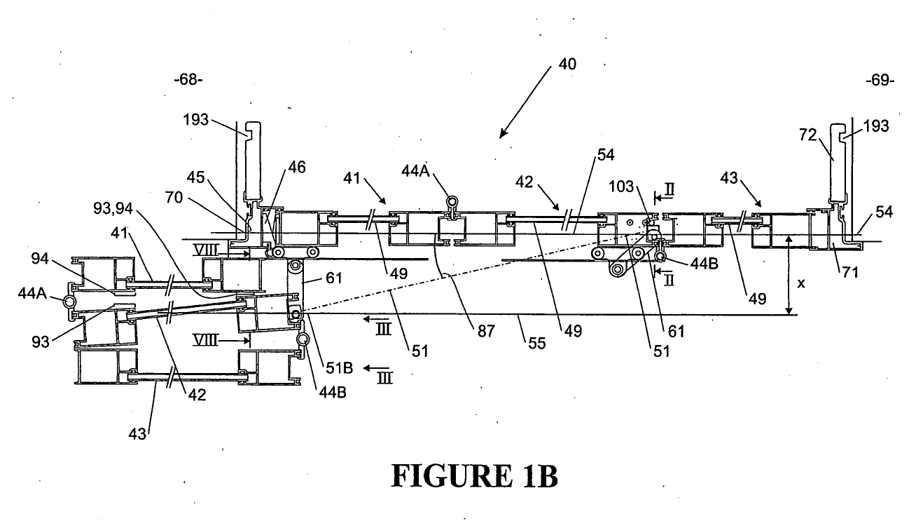

As shown in FIG. 1A, a multi-fold panel assembly 40 consists of a first panel 41, a second panel 42 and optionally a third panel 43. The third panel 43 is located from the distal end of the second panel 42 away from the first panel via a hinge 44B. The preferred arrangement of FIG. 1A would be referred to as a three panel configuration. Other configurations such as a 2 panel configuration where panels 41 and 42 alone are provided are considered also. Other configures can be envisaged such as a mirror image of panels 41 and 42 to the right of panel 43 opening away and to the right on a similar skewed track (a so called three-two configuration). Other configurations such as a two-two configuration (panels 41 and 42 fold away to the left hand side and mirror images of 41 and 42 folding away to the right hand side), and other such configurations of three, two and one panels are possible also. The first panel 41 may be hung off the surrounding frame 45 via a hinge 46, where subsequent panels are hung off the first and second panel via hinges 44A and 44B. Openings could also be spanned with multiple sets of multi-fold panel assemblies, e.g. one assembly from the left hand side and one from the right. Each hinge alternates on its' side of the door so that the assembly of the multi-fold panel may be folded in the concertina like manner. Depicted in the preferred embodiment of the present invention the centre section of each panel (41, 42 or 43) is glazed 49, though any means for filling the opening may be used such as opaque or translucent materials, or solid materials to form barriers or at least to partially close the opening.

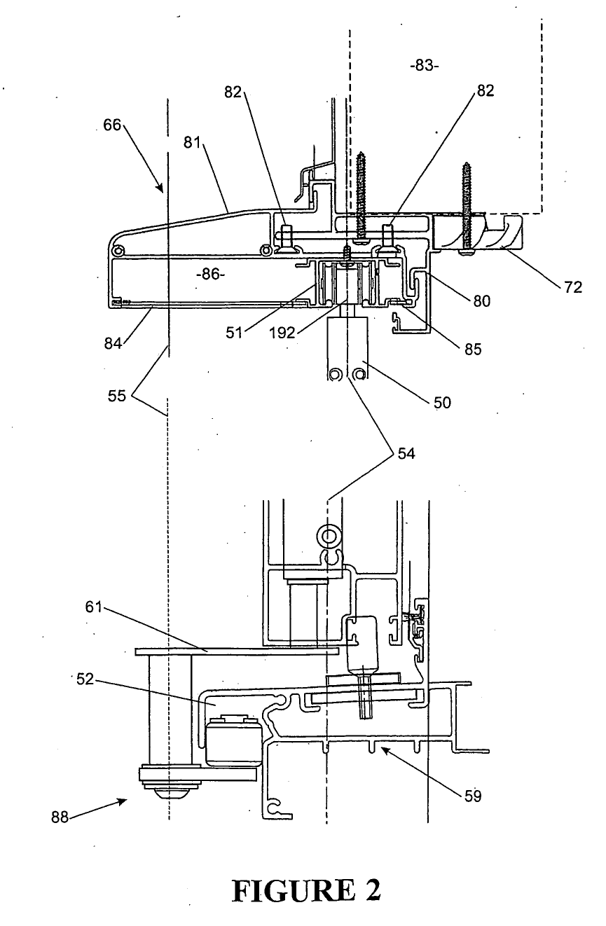

Due to the weight of the panels that hangs on the hinge 46 a top runner 50 is engaged on a top skewed rail 51 via four bearinged rollers 53 which travel inside the top skewed rail 51 as shown in FIG. 2. The top runner 50 is a supporting runner which is of a bogie like construction. The top runner provides vertical support the panels from the point of engagement of the bogie with the panels independent from the top skewed rail 51. The skewed rail 51 is preferably of constant cross section. The rollers 53 and the vertical pivot 192 thereof are preferably positioned about the mid thickness “X” of the panels.

The top rail 51 (preferably an extrusion) need not be angled over the entire travel distance to the opening, but rather may be parallel to the plane of opening and closing (55 and 54 respectively) for the majority of its length and then move from the open plane 55 to the closed plane 54 at the very last length of door travel. Such track need not be straight or simply angled but may curve at a point along its length to allow folding of the door panels into opened plane 55 when opened. For example the track may be “s” shaped at its end of travel toward the fixed hinged end 68.

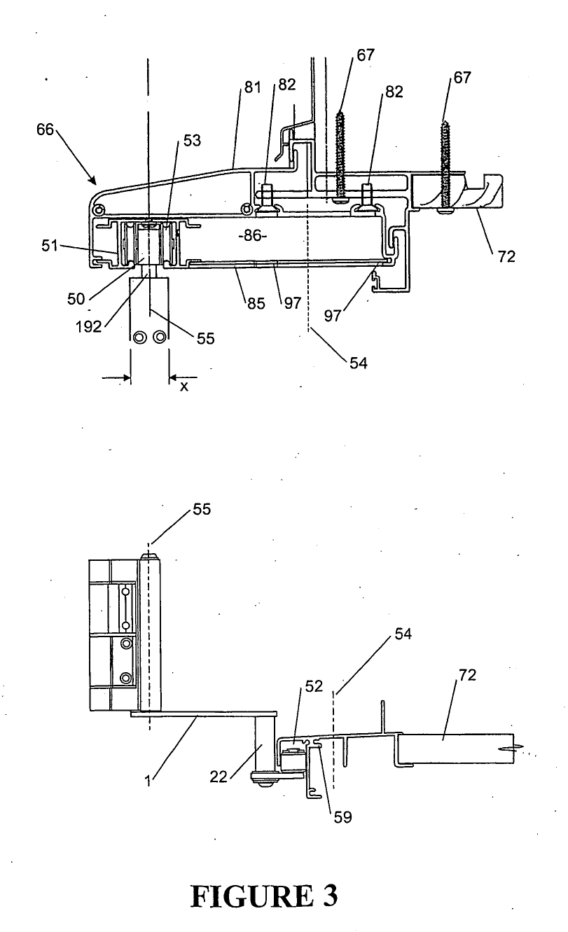

The assembly in vertical cross-section is shown in FIGS. 2 and 3, the exterior of the doorway being on the left hand side of the page. On FIG. 1B the interior of the opening is on the upper portion and the exterior of the opening is on the lower portion.

Assembled about the moving multi-fold panel assembly is a frame consisting of lower extrusion 59 and upper assembly 66 associated with each other via side frame members 70 and 71. The lower portion of the frame is defined by a lower extrusion 59 which in this embodiment has a track 52 associated within it. However it may be a separate track is attached to the lower extrusion 59 whilst the lower extrusion is preferred for the purposes of tracked support of the door panels, it is not essential.

Accordingly the closure assembly of the present invention is a fully framed item and can be handled as a unit for insertion into an opening of a building. The entire assembly can be positioned into the opening without the need for any additional at least structural components and/or hanging of doors subsequent to the engagement at the opening of the structure.

The upper assembly 66 consists of a foundation frame member 80, a pelmet extrusion 81 adjustably attached to the base extrusion via threaded fasteners 82 and a top skewed rail 51, with which the top runner 50 is engaged. The pelmet extrusion 81 preferably carries and preferably in a fixed and secured condition, the top rail 51. The foundation extrusion 80 is attached by penetrative fastenings 67 to the framing timbers 83 (shown in phantom). The top skewed rail 51 is located on an angle within the pelmet frame 81 and has soffit members 84 and 85, roughly triangular shaped, to close off the void 86 of the pelmet extrusion, for aesthetic purposes.

An opening, such as that to be selectively closed by the present invention will normally have timber framing (such as 83) or the like defining the opening. The framing of the opening provides a mount for the multi fold panel assembly to be fastened to. In the preferred embodiment penetrative fastenings 67 (e.g. screws or nails) are used that pass through part of the surround comprised of upper assembly 66, vertical extrusions 70 and 71, and lower extrusion 59) of the multi fold panel into the framing members, e.g. framing timbers 83 in this case.

At the hinged end 68 and the free end 69 of the multi-fold panel assembly, are vertical extrusions 70 and 71. The four extrusions (70, 71, 59 and 80) are preferably pre-assembled together to provide a surrounding frame 45 in which the multi-fold panel assembly is positioned and moves.

Fascia 72 (or reveals or liners, such as those made of wood) attach to the periphery of the frame to provide in part a means to secure the frame to the building, and also provide an aesthetically appealing interior finish. Rebates 193 in such fascia 72 may be provided to receive an edge of interior wallboard lining.

It is desirable for such multi-fold panel assemblies when open (such as shown at the right hand side of FIG. 1) to lie each in its own plane which is a plane parallel to that which they are in when closed (e.g. the plane of the opening). Further more this position should be out of the way of the opening of the frame which they are to close. Such a concertina position allows fill access in and out of the doorway, has no protruding panels or similar in which to catch or be walked into, and also provides an aesthetically pleasing look to the door when opened.

When moving through from the closed position to the opening position (to lie folded against the exterior of the building) the panel to which the top runner 50 is attached, the second panel 42 in FIG. 1, must track from the plane 54 in which the door lies when closed rail extrusion to the plane 55 in which the panel 42 substantially lies when open. To achieve this the top skewed rail extrusion 51 in which the top runner 50 is engaged must be on a skewed angle from the closed plane to the open plane, 54 and 55 respectively. Such an angle (87 in FIG. 1) will vary depending upon the width of the aperture to be opened (i.e. the width of panels 41 and 42) and thickness of the panels used which defines the out of plane 54 movement of the top runner by distance x to plane 55. The not inconsequential weight of part of the panels is supported and also guided throughout its movement by the track 51. The critical point of its movement when most weight is applied as tension or the track 51 is when the panel 42 is at 90 degrees to the plane of the opening 54.

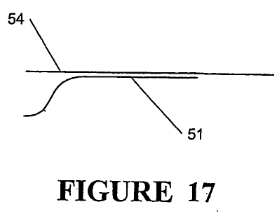

The skewed track need not be straight. It may only skew at a region towards or at the edge of the opening of the multi-fold panel (i.e. toward end 68), sufficient to allow the bogie on top runner 50 for panel 42 to move out of the closed plane 54 to the open plane 55 so skewing of the support track need not be across the full extent of the scope of the closed condition of the two panels but can be a partial skewing over only part of the opening in that respect see for example FIG. 17.

The closed position of the panel 42 in cross section is shown in FIG. 2. The closed door second panel 42 lies in the closed plane 54. The closed and opened cross-sectional locations of the top skewed rail 51 are shown in FIGS. 2 and 3 respectively.

Upon opening, panels 41 and 42 break outwards (downwards in FIG. 1B) at hinge point 44A. The panel 42 tracks along the top rail 51 from closed to open positions and vice versa. In moving from the closed plane 54 to the open plane 55, the panel 42 comes to lie in or nearly parallel to the opened plane position 55, and hence is rotated about hinge 46 through 180 degrees.

For aesthetic purposes it is preferable not to have a skewed track in the bottom extrusion 59 (although this can be done as an alternative or in addition) that forms the lower part of the overall frame in which the multi-fold panel opens and closes.

A lower track 52 of a different kind is however preferably provided for security reasons and also to guide the panels about pivot 44B. The track prevents in part, in the closed position, the door from being pulled off its hinges from below (for example by external force or wind pressure). It also holds the distal end of the distal panel 42 in it plane 55 when in the open condition. Through the opening sequence the lower track provides a guide means and imparts rigidity to the opening of the door in conjunction with the lower runner 88.

The lower runner 88 has the function once the door multi-fold panels have been opened to hold the resulting folded assembly together and prevent at least the panel 42 from swinging outwardly at its bottom edge.

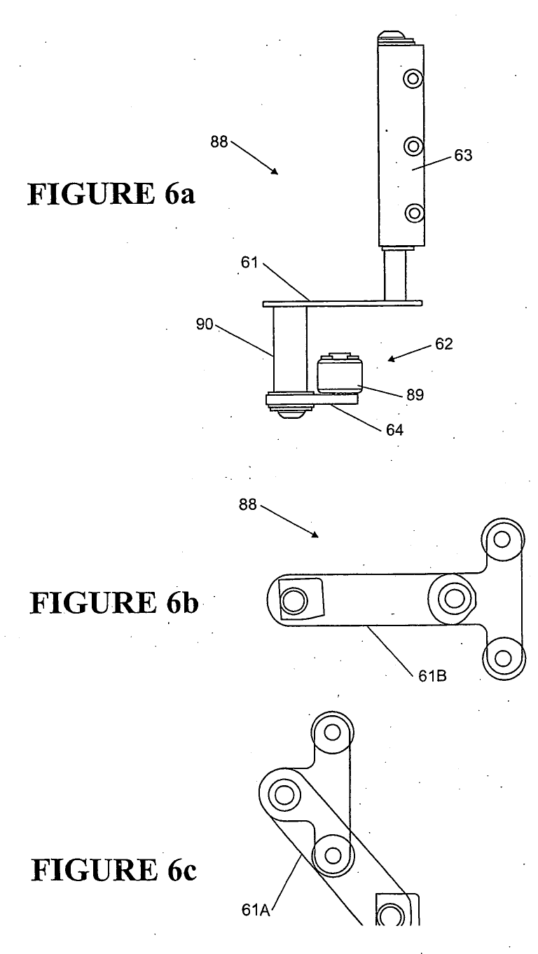

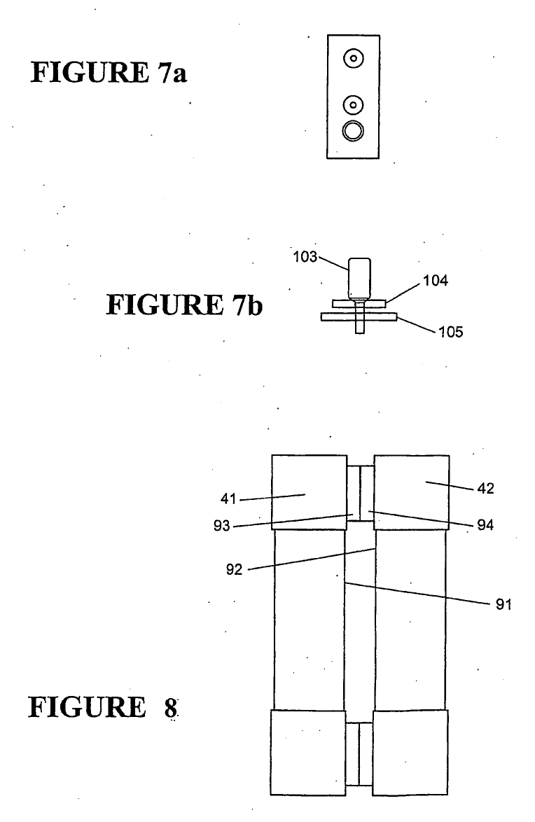

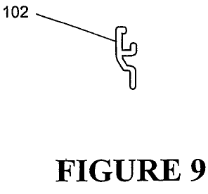

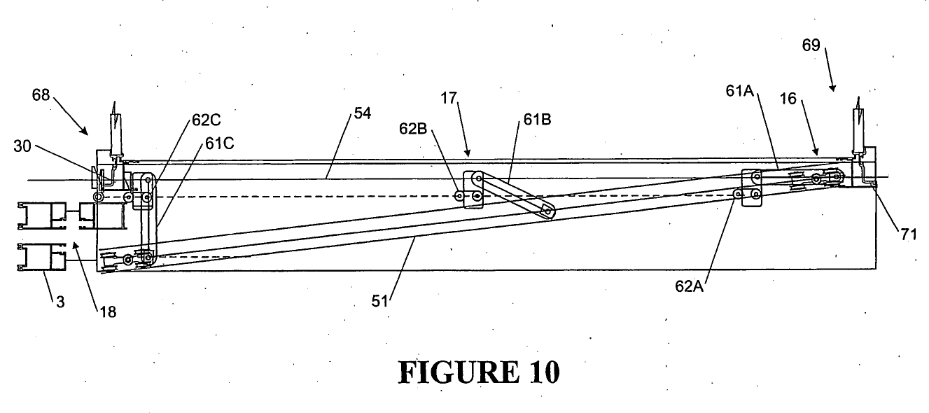

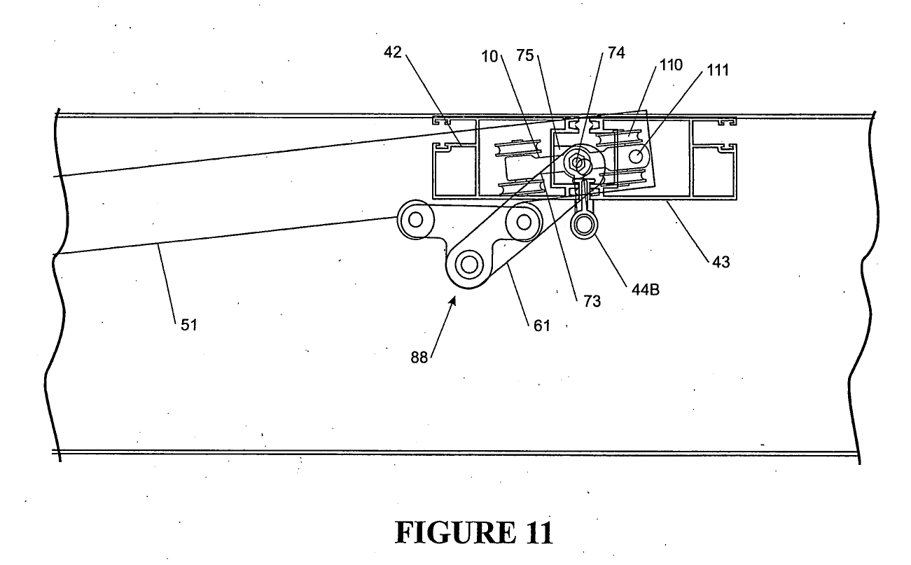

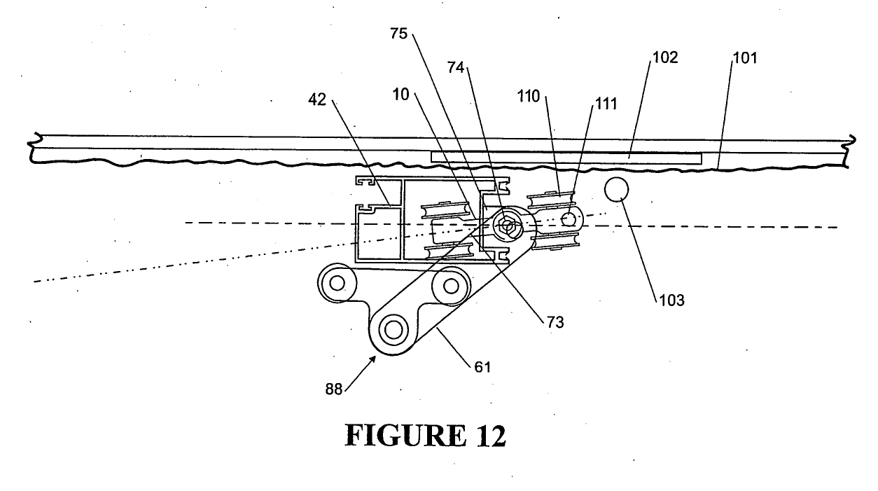

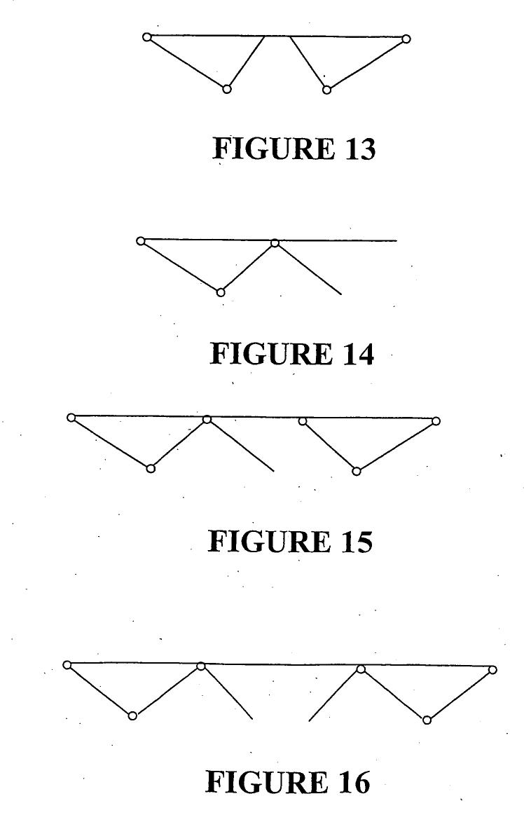

As the alternative to having a skewed track for the registering of the bottom of the panels with the frame, and in order to utilise a straight track 52 (i.e. parallel to the opened or closed planes) on the lower frame 59, an extensile association is provided by articulation member 61 which allows the pivotal engagement of a lower runner 62 (with rollers 89) to travel in a straight line (parallel to the open and closed planes) with the panel 42 as it moves out from plane 54 to its open condition. FIG. 10 shows the movement of the lower runner 62 through the closed, midway and fully open positions 62A, 62B and 62C respectively in relation to the articulation arm 61 which moves from a position 61A substantially parallel to the closed plane 54 through an arc of approximately 90 degrees (through 61B) to lie at the position 61C. In the fully opened condition the arm preferably extends at 90 degrees to the plane 54 as any movement to the panel with which the runner assembly 88 is engaged e.g. as a result of wind loading, will be significantly in a direction at 90 degrees to such a plane. Accordingly if the arm 61 extends parallel to such a direction, it is able to provide maximum rigidity to ensure holding of the panel. The more preferred form of runner assembly 88 as per FIG. 6 may not have the arm 61 move through 90 degrees. This therefore allows the lower runner 88 to travel on a lower straight line parallel to the open and closed planes whilst allowing the point axially aligned with the top runner 50 to travel through the skewed path whilst still being connected to the lower runner 88.

The lower runner 88 consists of an articulation hinge 63 which allows the panel to which it is attached to rotate freely in relation to the arm 61 which is guided by the lower track 52. Pivotally attached to the swing arm 61 is an arm 64 on which are rollers 89 of a bogie like assembly is provided. Preferably there are two rollers parallel aligned to travel on the lower track 52. Between the articulation hinge 63 and the arm 64 and its pivot 90 is interposed the swing arm 61.

The top runner 50 consists of four bearinged rollers 110 which sit on a bearing carriage 73, the bearing carriage being pivoted at a point 74 for a 3 panel door (as shown) which is hinged via the body 75 which is internally attached to the distant end of the distal panel (panel 42 in FIG. 1). The bearing carriage 73 can alternatively pivot at point 111 for a 2 or 4 panel unit. The pivot happens at pivot point 111 for 2 and 4 panel units so the gear does not (a), for a 2 panel bump into the jamb extrusion 71 when closed and (b) in a four panel, bump into each other where they meet at the middle of the door.

An alternative method of retaining at least panels 41 and 42 together (at the edges away from their respective hinged edges) for such similar purposes is shown in FIG. 8 whereby mutually attractive means (for example magnets but not limited thereto) are located on the inner faces 91 and 92 of the panels 41 and 42. The mutually attractive means 93 and 94 are at least located at facing positions of panels 41 and 42 when in the open condition at or towards the bottom of the panels. Preferably such mutually attracted means are also provided on facing surfaces of panel 43 and 42 when in the open condition to allow for panel 43 to be retained securely in the open condition against panel 42 yet still be conveniently releasable therefrom when it is desired to move the assembly to a closed condition. Such mutually attractive means may be provided either towards the top bottom or other location at the distal most end of the panel 43 facing panel 42. However a mechanical fastening means may also be provided for this purpose.

As part of the installation of the multi-fold panel assembly of the present invention in the configuration where the panels are supported from above (as shown in the drawings) the foundation frame member 80 of the upper assembly 66 is mounted to the surrounding frame work of wood (or other materials) 83 by penetrative fasteners 67. These hold the foundations frame member 80 fast and rigid to the surrounding frame work. The sub frame 81 such as a pelmet is fastened to the foundation frame member 80 by means of threaded fasteners engagement screws 82. These are preferably spaced either side of the closure plane 54 at regular intervals spaced along the length of the span of the pelmet 80. For example in FIG. 1 these fasteners would run either side of the line 54 between at least the hinge point 44B to the hinge point 46. Apertures 97 in the soffit 84 and 85, allow for a tool to be passed through the soffit to engage the fasteners 82 and turn them accordingly. Alternatively the soffit may be easily removable for access to be gained. The engagement of the head of the fastener with the pelmet 81 or resulting assembly 98 allows the pelmet 81 to be adjusted both up and down in the horizontal direction but also rotationally about an axis horizontal and parallel to the plane 54 to affect a rotational of movement of the pelmet frame in the resulting sub assembly relative to the foundation frame member 80. Such adjustment allows the top skewed rail extrusion 51 to be adjusted in relation to the top runner 50 to ensure that any sag of the upper assembly 26 is taken up so that the top runner or runners 50 does not jam within the rail and is allowed to run smoothly. Any such adjustment would be done after installation of the frame and multi-fold assembly once weight is exerted on the pelmet. Obviously as the pelmet 81 is moved the track 51 which is in integral (although preferably of a separate extrusion) with the pelmet 81 is moved accordingly.

Towards the end of movement of the closed condition of the multi-fold panel assembly the panel 42 and particularly the interior edge 99 of the distal vertical edge of panel 42 (at top and/or bottom) is brought close to and in many circumstances will hit the exterior facing rear edge 100 of the bottom frame extrusion where a seal 101 is provided. Repeated impact of this type can damage both the panel and the frame extrusion and also the seal 101 (preferably of a mohair type seal) in that vicinity. It is to be noted that such impact only occurs in the last portion of closing travel of such panels as 42. Therefore a bump extrusion 102 is provided, located in such a manner relative to the seal 101 so that the edge 99 will strike the extrusion 102 and not impact upon the frame 100 or towards the base of the seal 101. Such a bump extrusion may be replaceable and/or at least sacrificial for this purpose. Materials for such extrusions may be of a plastics material or other such replaceable materials but which will not damage the coating of panel 42.

A retention pin 103 is located on the lower frame at the position where the panel 42 is located in the closed condition to engage the lower portions of the leading edge of the panel 42 such that when the panel is in an enclosed position the panel (or panels attached to) cannot swing out from the bottom frame. Such movement may occur under wind loading or by force applied to the bottom edge of the panel in the closed position. Thus when the panel is closed and locked it cannot be forced open at either the top or the bottom of the frame. The retention pin 103 is mounted on mounting plates 104 and 105 respectively which are fastened to the lower extrusion 59. A like pin may also be used to capture the panel 41 against frame at closed condition.

Where panels are bottom guided and supported or both bottom and top supported the pelmet arrangement can be reversed to be (or also be) provided at bottom. However adjustment need not be necessary at bottom since no cantilevered support need be provided.

The lower runner 88 arrangement can in reversed circumstances, be positioned at the top.

1. A closure assembly of an opening of or in a building or like structure, said closure assembly including at least two mutually pivoted panels (glazed or otherwise) mounted with the mutual pivot axis at least substantially vertical and so as to be movable between:
(i) a closed condition whereby said at least two panels at least substantially in mutual alignment provide at least a partial closure of said opening in or substantially parallel to the plane of the opening, and
(ii) an opened condition whereby said at least two panels, mutually disaligned by having pivoted mutually towards each other, are substantially clear of the plane of the opening and where one of each, or all of at least two panels, lie at an acute angle or parallel with respect to the plane of the opening,
wherein one of said panels (the “proximate panel”) is pivoted by an at least substantially vertical pivot axis substantially in the plane of the opening at and/or adjacent a vertical periphery of said opening (“the proximal periphery”),
and wherein the distal region of the other panel (the “distal panel”) is supported by at least one supporting runner,
wherein the supporting runner running on a support track which, at least in part is skewed, angled or angling, cranked or curved (hereafter “skewed”) with respect to the plane of said opening, has the affect of spacing the supporting runner out of the plane of said opening at/or adjacent said proximal periphery.

2. A closure assembly as claimed in claim 1 wherein the proximate panel is pivoted by a substantially vertical pivot axis fixed relative to said opening.

3. A closure assembly as claimed in claim 1 wherein said proximate panel is pivoted by a substantially vertical pivot axis horizontally movable relative to and within the plane of the opening.

4. A closure assembly as claimed in claim 1 wherein said supporting runner includes a wheeled bogie engaged with the support track.

5. A closure assembly as claimed in claim 1 wherein said support runner includes a vertical axis pivot to allow said wheeled bogie to pivot relative to said distal panel about a vertical axis.

6. A closure assembly as claimed in claim 5 wherein said vertical axis of said pivot of said wheeled bogie is located at the mid thickness of said distal panel.

7. A closure assembly as claimed in claim 1 wherein the support track is substantially rectilinear in form and is at an acute angle with respect to the plane of the opening.

8. A closure assembly as claimed in claim 1 wherein the support track is at least in part rectilinear in form and said part is at an acute angle with respect to the plane of the opening.

9. A closure assembly as claimed in claim 1 wherein the support track is rectilinear in form and parallel with the plane of the opening (preferably in the plane of the opening) save for that part thereof immediately proximal to the proximal periphery, where said track is angled to the plane of said opening to step the supporting runner out of the plane of the opening.

10. A closure assembly as claimed in claim 1 wherein the support track is curved.

11. A closure assembly as claimed in claim 1 wherein the distal region of the distal panel is supported by one supporting runner affixed at either the top or bottom (the “vertical supported location”) of the distal panel.

12. A closure assembly as claimed in claim 11 wherein the other of said top or bottom to said vertical supported location is associated with a guiding runner tracked by a guiding track in the plane or parallel to the plane of the opening, such guiding runner nevertheless allowing by means of an extensile association of the guiding runner with the distal panel, movement for the distal panel in following the support track defined locus allowing the distal region of the distal panel to move as guided and pivoted with respect to the opening by the supporting runner guided by the support track.

13. A closure assembly as claimed in claim 11 wherein the other of said top or bottom to said vertical supported location is associated with a guiding runner tracked by a guiding track in the plane or parallel to the plane of the opening, such guiding runner including an extensile arm pivotally attached to the distal panel, said extensile arm allowing the following of the support track defined locus required to allow the distal region of the distal panel to move as constrained by said support track.

14. A closure assembly as claimed in claim 12 wherein the guiding runner includes an articulation means extending in a pivotal manner between the distal panel (at or towards the distal region) said articulation means being further pivotally associated with said guiding track via a runner bogie located with and guided by the guiding track, thereby providing said extensile association.

15. A closure assembly as claimed in claim 14 wherein said articulation means is a rigid arm.

16. A closure assembly as claimed in claim 15 wherein said rigid arm extends perpendicular to said plane of said opening when said panels are in said open condition.

17. A closure assembly as claimed in claim 1 wherein the support runner is provided at the top of the distal panel.

18. A closure assembly as claimed in claim 12 wherein the guide runner is located at the bottom of the distal panel.

19. A closure assembly as claimed in claim 12 wherein the guide runner is provided at the top of the distal panel and the supporting runner is located at the bottom of the distal panel.

20. A closure assembly as claimed in claim 1 wherein the distal region of the distal panel is supported by a top and bottom located supporting runner, each supporting runner running in a respective said support track, disposed at the top and bottom of the opening.

21. A closure assembly as claimed in claim 1 wherein the proximal panel is pivoted by a fixed vertical pivot axis at the proximal periphery.

22. A closure assembly as claimed in claim 1 wherein said panels in an open position, lie substantially parallel to the plane of the opening.

23. A closure assembly as claimed in claim 1 wherein the closure assembly is fully framed.

24. A closure assembly as claimed in claim 1 wherein the perimeter of said closure assembly is defined by a frame structure of a size commensurate to being received in said opening of or in said building or like structure.

25. A closure assembly as claimed in claim 1 wherein the perimeter of said closure assembly is defined by a frame structure of a size commensurate to being received in said opening of or in said building or like structure said frame including a top frame extrusion, and a bottom frame extrusion parallel to said top frame extrusion and to extend horizontally in use, and two side frame extrusions affixed to and extending between said top and bottom frame extrusion and parallel to each other and to in use extend vertically.

26. A closure assembly as claimed in claim 23 wherein said frame is at least in part an assembly of extruded forms.

27. A closure assembly as claimed in claim 1 wherein said supporting runner is a top runner affixed to a top or upper part of said distal panel, and wherein said opening of or in said building includes head framing, said support track is incorporated in a head assembly, said head assembly including
a) a longitudinally extending foundation member to be fastened to the head framing of said opening with its longitudinal direction parallel to the plane of said opening,
b) a subassembly carrying the support track, fastened to said foundation member yet in a manner to allow the displacement of the said support track in a manner selected from one or more of
(i) a linear manner to and from the bottom of said opening, and
(ii) a manner to allow the tilt of said track about a horizontal axis parallel to the plane of said opening.

28. A closure assembly as claimed in claim 25 wherein said supporting runner is a top runner affixed to a top or upper part of said distal panel, wherein said top frame member is a head assembly, said head assembly including
a) a longitudinally extending foundation member to be fastened to the building and in a manner with its longitudinal direction parallel to the plane of said opening,
b) a subassembly carrying the support track, fastened to said foundation member yet in a manner to allow the displacement of the said support track in a manner selected from one or more of
(i) a linear manner to and from the foundation member, and
(ii) a manner to allow the tilt of said track about a horizontal axis parallel to the plane of said opening.

29. A closure assembly as claimed in claim 28 wherein said foundation member is fixed to said side frame members.

30. A closure assembly as claimed in claim 28 wherein said subassembly is engaged to said foundation member by two arrays of vertically extending adjustment screws, a first array and a second array parallel to each other and to the plane of the opening, wherein the differential adjustment of the screws in one array to the other array inducing said tilt and wherein corresponding adjustment of the screws in the first array and the second array inducing the linear displacement.

31. A closure assembly as claimed in claim 28 wherein said subassembly includes a pelmet with which said track is fastened and disposed therefrom in a manner to be exposed for engagement with the supporting runner.

32. A closure assembly as claimed in claim 31 wherein said pelmet extends outwardly from the plane of the opening sufficient to present from below thereof said support track and to allow the spacing of the supporting runner to assume the opened condition.

33. A closure assembly as claimed in claim 31 wherein said pelmet is an elongate substantially constant cross section extruded member.

34. A closure assembly as claimed in claim 33 wherein said pelmet includes trimming panels on each side of said support track spanning the gap between said support track and the longitudinal edges of said pelmet.

35. A closure assembly as claimed in claim 30 wherein said first array of fastening screws is provided parallel to and on a first side of said plane of said opening and the second array is provided parallel to and on the other side of said plane of said opening.

36. A closure assembly as claimed in claim 30 wherein said screws of each array are equispaced.

37. A closure assembly as claimed in claim 1 wherein a locking pin is provided fixed to said structure, said locking pin positioned to engage at distal region of said distal panel against an outwardly facing surface of said distal panel when said panels are at and proximate to its closed condition to capture from moving outwardly.

38. A closure assembly as claimed in claim 25 wherein a locking pin is provided fixed to said frame, said locking pin positioned to engage at distal region of said distal panel against an outwardly facing surface of said distal panel when said panels are at and proximate to its closed condition to capture said distal region against a jam portion of said frame to thereby prevent said distal region from moving outwardly.

39. A closure assembly as claimed in claim 25 wherein said distal panel is supported at a top or bottom thereof by a said support runner and wherein at the other of said top or bottom the distal region of said distal panel includes an outwardly facing surface and wherein a locking pin is provided fixed to said frame structure, said locking pin positioned to engage the outwardly facing surface of said distal panel when said panels are at and proximate to its closed condition to capture said distal region against a jam portion of said frame to thereby prevent said distal region from moving outwardly.

40. A closure assembly as claimed in claim 38 wherein said outwardly facing surface is a concealed to the outside surface of said distal panel.

41. A closure assembly as claimed in claim 1 wherein provided to the proximal periphery disposed region of said proximal panel on the to be distal panel facing side thereof when in the opened condition, is a first mutually attractive means, the distal panel being provided at a corresponding location to the location of said first mutually attractive means on a proximal panel facing side thereof when in the opened condition, with a second mutually attractive means to thereby allow the interaction of said mutually attractive means when said panels are in the opened condition to encourage said distal region of said distal panel to remain engaged to the proximal periphery disposed region of said proximal panel.

42. A closure assembly as claimed in claim 41 wherein said first and second mutually attractive means are magnetically attractive means.

43. A closure assembly as claimed in claim 41 wherein said first and second mutually attractive means are both magnets.

44. A closure assembly as claimed in claim 41 wherein said first and second mutually attractive means are positioned towards the bottom of said panels.

45. A bifold door and/or window structure
at least a proximal panel and a distal panel
wherein
(a) the distal panel is provided at/or adjacent a lower distal region with a pivot on an extension of or from a lower track runner tracked in the plane of the opening to be closed by the door and/or window panels and,
(b) the distal panel is provided at or adjacent an upper distal region with a means to provide pivot tracking from a support track of the structure, said support track being skewed at least in part (whether straight, curved, kinked or otherwise)
and wherein together (a) and (b) have the affect of moving a thus defined common distal pivot axis of the distal panel out of the plane of the opening as the panels are opening thereby to allow the bifold door or window structure concertina back away from the opening with the proximal panel adjacent the building structure and the distal panel adjacent the proximal panel.

46. A guiding runner for supporting a lower distal region of distal panel of a bifold or multi-fold door and/or panel structure from a track, said guiding runner having an arrangement adapted to pivotally attach to said distal region of said distal panel,
a runner adapted to track said track, and
a link between the pivotal attachment and the runner, said link including two substantially parallel pivot axes whereby the link can range in its disposition from being aligned or substantially aligned in the plane of the tracking locus or extend outwardly therefrom to effectively space the pivot most proximal to the door and/or window panel from such plane of the tracking locus.

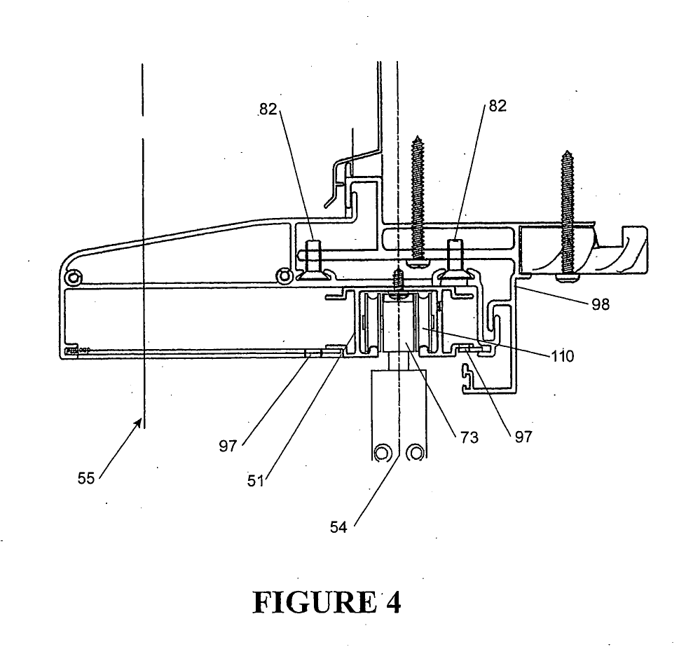

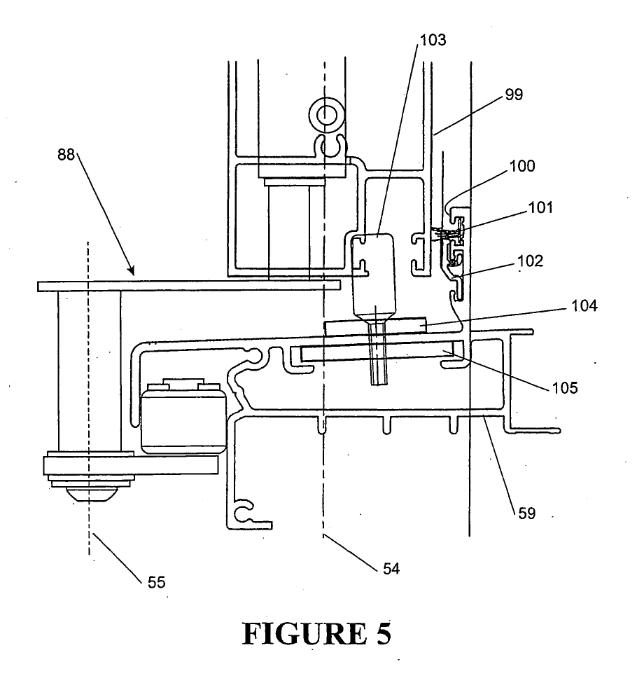

47. A guiding runner as claimed in claim 46 wherein such a guiding runner is substantially as hereinafter described with reference to any one or more of FIGS. 1B, 2, 3, 5, 6A-C, 11, 12.

48. Extrusions for framing an opening in a structure and for providing tracks for such a structure, wherein in subassembly or assembly they are adapted to form part of an assembly or structure of the closure assembly as claimed in claim 1.

49. In a building structure, a pair of tracks at an opening for a bifold or the like panel assembly, the lower track being in the plane of the opening and the upper track being skewed outwardly of the plane of the opening.

50. A bifold door and/or window structure comprising
at least a proximal panel and a distal panel
wherein
(a) the distal panel is provided at/or adjacent a lower or upper distal region with a pivot on an extension of or from a guiding track runner tracked in the plane of the opening to be closed by the door and/or window panels and,
(b) the distal panel is provided at or adjacent the other of said upper or lower distal region with a means to provide a pivot tracking from a support track of the door or window structure, said support track being skewed at least in part (whether straight, curved, kinked or otherwise)
and wherein together (a) and (b) have the affect of moving a thus defined common distal pivot axis of the distal panel out of the plane of the opening as the panels are opening thereby to allow the bifold door or window structure concertina back away from the opening with the proximal panel adjacent the building structure and the distal panel adjacent the proximal panel.

51. A guiding runner for supporting a lower or upper distal region of distal panel of a bifold or multi-fold door and/or panel structure from a track, said guiding runner having an arrangement adapted to pivotally attach to said distal region of said distal panel,
a runner adapted to track said track, and
a link between the pivotal attachment and the runner, said link including at least two substantially parallel pivot axes whereby the link can range in its disposition from being aligned or substantially aligned in or acute to the plane of the tracking locus when said bifold door is closed or extend outwardly therefrom to effectively space the pivot most proximal to the door and/or window panel from such plane of the tracking locus.

52. A guiding runner as claimed in claim 51 wherein such a guiding runner is substantially as hereinafter described with reference to any one or more of FIGS. 1B, 2, 3, 5, 6A-C, 11, 12.

53. Extrusions for framing an opening in a structure and for providing tracks for such a structure, wherein in subassembly or assembly they are adapted to form part of a closure assembly as claimed in claim 1.

54. In a building structure, a pair of tracks at an opening for a bifold or the like panel assembly, a first of said tracks positioned either as a lower or upper track and being in the plane of the opening and the second of said tracks being opposite to the first of said tracks being skewed outwardly of the plane of the opening.

55. In a building structure, a pair of tracks at an opening or a bifold or the like panel assembly, the upper track being in the plane of the opening and the lower track being skewed outwardly of the plane of the opening.

56. A pair of tracks at an opening or a bifold or the like panel assembly, the upper track being in the plane of the opening and the lower track being skewed outwardly of the plane of the opening, wherein said such track is of a kind capable of being used in a closure assembly as claimed in claim 1.

57. A building including a closure assembly to an opening of said building, said closure assembly including at least two mutually pivoted panels (glazed or otherwise) mounted with the mutual pivot axis at least substantially vertical and so as to be movable between:
(i) a closed condition whereby said at least two panels at least substantially in mutual alignment provide at least a partial closure of said opening in or substantially parallel to the plane of the opening, and
(ii) an opened condition whereby said at least two panels, mutually disaligned by having pivoted mutually towards each other, are substantially clear of the plane of the opening and where one of each, or all of at least two panels, lie at an acute angle or parallel with respect to the plane of the opening,
wherein one of said panels (the “proximate panel”) is pivoted by an at least substantially vertical pivot axis substantially in the plane of the opening at and/or adjacent a vertical periphery of said opening (“the proximal periphery”),
and wherein the distal region of the other panel (the “distal panel”) is supported by at least one supporting runner,
wherein the supporting runner running on a support track which, at least in part is skewed, angled or angling, cranked or curved (hereafter “skewed”) with respect to the plane of said opening, has the affect of spacing the supporting runner out of the plane of said opening at/or adjacent said proximal periphery.
